(19) United States
(12) Patent Application Publication
(10) Pub. No.: US 2026/0094810 A1
(43) Pub. Date: Apr. 2, 2026

(54) NEGATIVE ELECTRODE FOR SECONDARY BATTERY AND MANUFACTURING METHOD OF SECONDARY BATTERY WITH NEGATIVE ELECTRODE

(71) Applicant: Prime Planet Energy & Solutions, Inc., Tokyo (JP)

(72) Inventor: Harumi MASUI, Kobe-shi (JP)

(21) Appl. No.: 19/326,726

(22) Filed: Sep. 12, 2025

(30) Foreign Application Priority Data
Sep. 27, 2024 (JP) 2024-169483

(51) Int. Cl. H01M 4/36; H01M 4/02; H01M 4/38; H01M 4/583; H01M 10/0525

(52) U.S. Cl. CPC H01M 4/364; H01M 4/366; H01M 4/386; H01M 4/583; H01M 10/0525; H01M 2004/021; H01M 2004/027

(57) ABSTRACT

The negative electrode of the secondary battery of a present disclosure is a negative electrode for secondary battery that includes a negative electrode current collector, and a negative electrode active material layer supported by the negative electrode current collector. The negative electrode active material layer includes a lower layer positioned at the negative electrode current collector side and an upper layer positioned at a surface side. The upper layer includes a first graphite particle and a first Si-containing particle, as a negative electrode active material, and the lower layer includes a second graphite particle and a second Si-containing particle, as the negative electrode active material. An expansion rate P1 of the first Si-containing particle is smaller than an expansion rate P2 of the second Si-containing particle, and a mean particle diameter M1 of the first Si-containing particle is smaller than a mean particle diameter M2 of the second Si-containing particle.

### CROSS REFERENCE TO RELATED APPLICATIONS

The present application claims the priority based on Japanese Patent Application No. 2024-169483 filed on Sep. 27, 2024. The entire contents of the prior application are incorporated in the present description by reference.

### BACKGROUND

### 1. Technical Field

A present disclosure relates to a negative electrode for a secondary battery and a manufacturing method of the secondary battery in which the negative electrode is used.

### 2. Background

Recently, a secondary battery is suitably used for a portable power supply, such as personal computer and portable terminal, a power supply for driving automobiles, such as battery electric vehicle (BEV), hybrid electric vehicle (HEV), and plug-in hybrid electric vehicle (PHEV), or the like.

Regarding a purpose for the power supply for driving automobiles, especially regarding a purpose for the power supply for driving the BEV, from a perspective of extending a driving distance of the vehicle, it is desired to make the secondary battery have a higher capacity. As a negative electrode active material whose capacity is high, a Si-containing particle is known, and it is known, with the Si-containing particle, to be able to make the secondary battery have the higher capacity (for example, Japanese Patent Application Publication No. 2010-033830). Japanese Patent Application Publication No. 2010-033830 discloses a technique for using plural particles containing an elemental Si, a Si chemical compound, and a carbon, as a negative electrode active material.

However, although the Si-containing particle has the higher capacity, it has a larger volume change caused by an expansion/contraction when the secondary battery is electrically charged and electrically discharged. Then, in a situation where the Si-containing particle and the graphite particle are used together as the negative electrode active material, when an electrical charge and an electrical discharge are repeated on the secondary battery, there is a problem that an inside stress is increased due to a swell of the negative electrode. Thus, regarding the negative electrode that contains the Si-containing particle and the graphite particle, it is demanded to develop the negative electrode whose swell is smaller when the electrical charge and the electrical discharge are repeated on the secondary battery. Incidentally, this swell of the negative electrode represents that a volume of the negative electrode becomes larger than an initial volume on the same electrical charge state (for example, a state closer to a full charge near a SOC being 80%).

### SUMMARY

In view of the above described issue, the present disclosure has an object to provide a negative electrode which contains the Si-containing particle and the graphite particle and whose swell is smaller when the electrical charge and the electrical discharge are repeated on the secondary battery.

The herein disclosed negative electrode is a negative electrode for a secondary battery that includes a negative electrode current collector, and includes a negative electrode active material layer supported by the negative electrode current collector. The negative electrode active material layer includes a lower layer positioned at a side of the negative electrode current collector and an upper layer positioned at a surface side. The upper layer includes a first graphite particle and a first Si-containing particle, as a negative electrode active material. The lower layer includes a second graphite particle and a second Si-containing particle, as the negative electrode active material. An expansion rate P1 of the first Si-containing particle is smaller than an expansion rate P2 of the second Si-containing particle. A mean particle diameter M1 of the first Si-containing particle is smaller than a mean particle diameter M2 of the second Si-containing particle.

According to the configuration as described above, when it is used as the negative electrode for the secondary battery and the electrical charge and the electrical discharge are performed, it is possible to further reduce the swell of the negative electrode active material layer at the surface side in the negative electrode active material layer formed with the 2-layers structure having the negative electrode current collector side and the surface side. Further, the negative electrode active material at the negative electrode current collector side suffers the effect of the expansion of the negative electrode active material positioned at the surface side and thus the expansion of it can be inhibited. As the results, it is possible to suppress the swell, on the whole negative electrode active material layer. Then, it is possible to provide the negative electrode for the secondary battery which includes the Si-containing particle and the graphite particle and whose swell is smaller when the electrical charge and the electrical discharge are repeated on the secondary battery.

In one suitable aspect of the herein disclosed negative electrode, a ratio P1/P2 of the P1 and the P2 is 0.5 to 0.8. By doing this, it is possible to implement an aspect in which the negative electrode active material further hardly expanded is used at the surface side and the negative electrode active material layer at the surface side is made to be hardly expanded, and thus it is possible to further significantly implement suppressing the swell of the negative electrode.

In one suitable aspect of the herein disclosed negative electrode, a ratio M1/M2 of the M1 and the M2 is 0.4 to 0.6. By doing this, the negative electrode active material whose particle diameter after the expansion is smaller is used at the surface side, and thus it is possible to further significantly implement suppressing the swell of the negative electrode.

In one suitable aspect of the herein disclosed negative electrode, a ratio T1:T2 of a thickness T1 of the upper layer and a thickness T2 of the lower layer is 10:90 to 90:10. By doing this, it is possible to implement the aspect in which the negative electrode active material further hardly expanded is used at the surface side and the negative electrode active material layer at the surface side is made to be hardly expanded, and thus it is possible to further significantly implement suppressing the swell of the negative electrode.

In one suitable aspect of the herein disclosed negative electrode, a mass rate N1 of the first Si-containing particle with respect to a total mass of the first graphite particle and the first Si-containing particle on the upper layer is 10 to 60 mass %, and a mass rate N2 of the second Si-containing particle with respect to a total mass of the second graphite particle and the second Si-containing particle on the lower layer is 10 to 60 mass %. By doing this, it is possible to implement an aspect in which the negative electrode active material layer at the surface side is further hardly expanded, and thus it is possible to further significantly implement the effect of the swell of the negative electrode.

The herein disclosed secondary battery is a secondary battery that includes a positive electrode, a negative electrode, and an electrolyte, and the negative electrode is the herein disclosed negative electrode.

According to the configuration as described above, it is possible to implement the secondary battery in which the swell of the negative electrode in response to the electrical charge and the electrical discharge is suppressed and which has the higher capacity.

### BRIEF DESCRIPTION OF THE DRAWINGS

FIG. 1 is a cross section view that schematically shows an example of a negative electrode 60 in accordance with the present embodiment, and is a cross section view that is shown along a thickness direction and a width direction.

FIG. 2 is a schematic cross section view that shows a particle of a negative electrode active material contained in the negative electrode active material layer 64 shown by FIG. 1.

FIG. 3 is a view that schematically shows a configuration of a lithium ion secondary battery constructed with the negative electrode in accordance with one embodiment.

FIG. 4 is a schematic exploded view that shows a configuration of a wound electrode assembly of the lithium ion secondary battery shown by FIG. 3.

### DETAILED DESCRIPTION

Below, a preferred embodiment of a herein disclosed technique would be explained. Incidentally, the matters other than matters particularly mentioned in this description and required for implementing the herein disclosed technique can be grasped as design matters of those skilled in the art based on the related art in the present field. The herein disclosed technique can be executed based on the contents disclosed in the present description, and the technical common sense in the present field. Additionally, in drawings explained by the present description, the members/parts providing the same effect are provided with the same numerals and signs and are explained, and overlapped explanation might be omitted or simplified. Additionally, a dimensional relation (a length, a width, a thickness, and the like) in each drawing does not always reflect the actual dimensional relation.

A wording “secondary battery” in the present description is a term denoting electricity storage devices that are capable of repeatedly charging and discharging in response to a movement of a charge carrier between a positive electrode and a negative electrode, and is a concept that semantically covers a so-called storage battery (a chemical battery), such as lithium ion secondary battery and sodium ion secondary battery, and a capacitor (a physical battery), such as lithium ion capacitor (LIC). Below, main configuration materials of the secondary battery in accordance with the present disclosure will be described. Incidentally, as configuration materials of the secondary battery not described here, it is possible to use conventionally known ones.

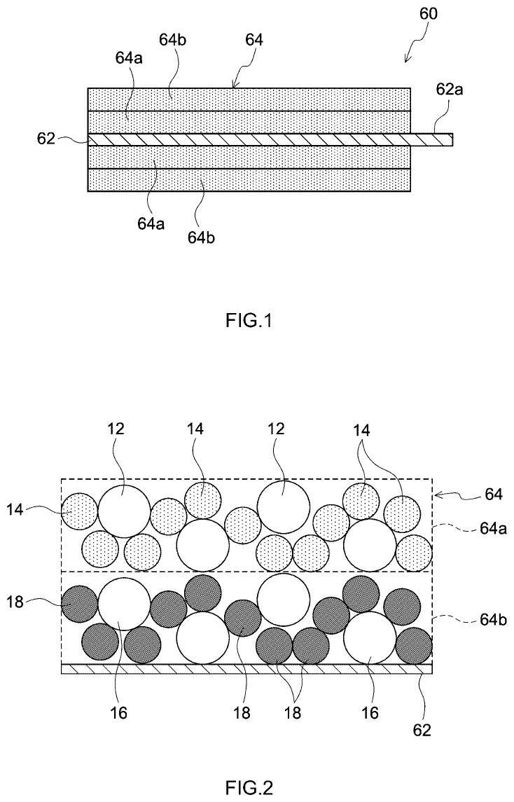

The herein disclosed negative electrode is used for a secondary battery, or suitably used for a lithium ion secondary battery. One embodiment of the herein disclosed negative electrode would be particularly explained, while referring to FIG. 1. FIG. 1 is a cross section view that schematically shows an example of a negative electrode 60 in accordance with the present embodiment, and is a cross section view that is shown along a thickness direction and a width direction. The negative electrode 60 in accordance with the present embodiment shown by FIG. 1 is the negative electrode of the lithium ion secondary battery.

### 1. Negative Electrode

### (1) Configuration of Negative Electrode

As shown in FIG. 1, the negative electrode 60 includes a negative electrode current collector 62 and a negative electrode active material layer 64 that is supported by the negative electrode current collector 62. In other words, the negative electrode 60 includes the negative electrode current collector 62 and the negative electrode active material layer 64 that is provided on the negative electrode current collector 62. The negative electrode active material layer 64 might be provided on only one surface of the negative electrode current collector 62 or might be provided on both surfaces of the negative electrode current collector 62 as shown by FIG. 1. It is preferable that the negative electrode active material layer 64 is provided on both surfaces of the negative electrode current collector 62.

The negative electrode 60 might include a member other than the negative electrode current collector 62 and the negative electrode active material layer 64. For example, on a negative electrode active material layer non-formation part 62a, an insulation layer (not shown in drawings) might be provided that is positioned adjacent to the negative electrode active material layer 64. This insulation layer includes, for example, an inorganic filler having an insulating property, or the like.

As shown in FIG. 1, the negative electrode active material layer non-formation part 62a in which the negative electrode active material layer 64 is not provided might be provided at one of end parts in the width direction of the negative electrode 60. On the negative electrode active material layer non-formation part 62a, the negative electrode current collector 62 is exposed and thus the negative electrode active material layer non-formation part 62a can function as an electrical collector part. However, a configuration for electrically collecting from the negative electrode 60 is not restricted by this.

A shape of the negative electrode current collector 62 is a foil shape (or a sheet shape) in the illustrated example, but it is not restricted by this. The negative electrode current collector 62 might be formed in a rod shape, a plate shape, a mesh shape, or the like. As a material of the negative electrode current collector 62, similarly to a conventional lithium ion secondary battery, it is possible to use a metal having a good electrically conductive property (for example, copper, nickel, titanium, stainless steel, or the like), and the copper is preferable among them. As the negative electrode current collector 62, it is especially preferable to use a copper foil.

A size of the negative electrode current collector 62 is not particularly restricted, and it is good to be suitably decided in accordance with a battery design. In a situation where the copper foil is used as the negative electrode current collector 62, a thickness of it is not particularly restricted, but it might be, for example, equal to or more than 5 μm and not more than 35 μm, or preferably equal to or more than 6 μm and not more than 20 μm.

As shown in FIG. 1, the negative electrode active material layer 64 has a multilayer structure, and particularly includes a first layer 64a positioned at a surface side of the negative electrode active material layer 64 and a second layer 64b positioned at the negative electrode current collector 62 side. As shown in FIG. 1, the first layer 64a is an upper layer of the negative electrode active material layer 64 and the second layer 64b is a lower layer of the negative electrode active material layer 64. Incidentally, the negative electrode active material layer 64 might include layers other than the first layer 64a and the second layer 64b, within a range where an effect of the present disclosure is not significantly inhibited. For example, the negative electrode active material layer 64 might include a middle layer between the first layer 64a and the second layer 64b, as components of these layers are mixed in the middle layer.

The negative electrode active material layer 64 contains a negative electrode active material. About this, it is explained in detail with FIG. 2. FIG. 2 is a schematic cross section view that shows a particle of the negative electrode active material contained in the negative electrode active material layer 64 shown by FIG. 1. Incidentally, FIG. 2 is a schematic view, and thus a number of the particles, a distribution of the particles, or the like, is not restricted to one shown by FIG. 2.

As the negative electrode active material, the first layer 64a includes a first graphite particle 12 and a first Si-containing particle 14. The second layer 64b includes a second graphite particle 16 and a second Si-containing particle 18. Thus, in the first layer 64a, as the negative electrode active material, at least the first graphite particle 12 and the first Si-containing particle 14 are used, and in the second layer 64b, as the negative electrode active material, at least the second graphite particle 16 and the second Si-containing particle 18 are used. The Si-containing particle has the large volume change caused by the expansion/contraction in response to the electrical charge and discharge, but when it is used together with the graphite particle, it is possible to suppress a disconnection of an electrically conductive path caused by the volume change of the Si-containing particle.

The graphite configuring the first graphite particle 12 and the second graphite particle 16 might be a natural graphite or an artificial graphite, or might be an amorphous carbon coated graphite having a form in which the graphite is coated with an amorphous carbon material.

The shapes of the first graphite particle 12 and the second graphite particle 16 are not particularly restricted, and might be scaly shapes, spheroidized shapes, or the like. The first graphite particle 12 and the second graphite particle 16 are preferably spheroidized graphite particles. In a situation where the first graphite particle 12 and the second graphite particle 16 are spheroidized, circularities of the first graphite particle 12 and the second graphite particle 16 are preferably 0.85 to 1, further preferably 0.88 to 1, or furthermore preferably 0.90 to 1.

Incidentally, the term “circularity” in the present description represents a ratio of a perimeter of a perfect circle whose area size is the same as a projected area size of a particle with respect to a perimeter of a particle projected (in other words, the circularity=the perimeter of the perfect circle whose area size is the same as the projected area size/the perimeter of the particle projected image). Thus, as the circularity is closer to 1, it means that the particle projected image is closer to the perfect circle and the particle becomes closer to a perfect spherical shape. The circularity can be obtained, for example, by using a commercially available static automatic image analysis apparatus, obtaining the circularities of 100 or more particles, and calculating a mean value of them.

A mean particle diameter (D50) of the first graphite particle 12 and a mean particle diameter (D50) of the second graphite particle 16 are not particularly restricted. Each of the mean particle diameter (D50) of the first graphite particle 12 and the mean particle diameter (D50) of the second graphite particle 16 is, for example, 1 μm to 30 μm, preferably 5 μm to 25 μm, further preferably 10 μm to 23 μm, or furthermore preferably 12 μm to 20 μm.

Incidentally, in the present description, the term “mean particle diameter (D50)” represents a median diameter (D50), and represents a particle diameter corresponding to cumulative frequency 50 volume % from a side of a fine particle, whose particle diameter is smaller, with respect to a particle size distribution on a volume basis according to a laser diffraction and scattering method. The mean particle diameter (D50) can be obtained with a commercially available particle size distribution measuring device configured in a laser diffraction and scattering style, or the like.

As the first graphite particle 12 and the second graphite particle 16, the same graphite particles might be used or different graphite particles might be used. As the first graphite particle 12 and the second graphite particle 16, it is preferable to use the same graphite particles.

As the first Si-containing particle 14 and the second Si-containing particle 18, it is possible to use, for example, one in which a fine particle containing a Si is dispersed at an inside of the carbon material; one in which the fine particle containing the Si enters into a void of a granulated porous graphite; or the like. The Si—C composite material might be one in which the fine particle containing the Si adheres to a surface of the carbon particle; one in which the carbon fine particle adheres to the surface of the particle containing the Si, or the like. From a perspective of suppressing the volume change of the Si, it is preferable to use one in which the Si nanoparticle is dispersed at the inside of the carbon material, and one in which the Si nanoparticle is dispersed inside the void of the porous carbon material, or it is further preferable to used one in which the Si nanoparticle is dispersed inside the void of the porous carbon material.

As one example of the first Si-containing particle 14 and the second Si-containing particle 18, for example, it is possible to use a particle of the Si—C composite material. The Si—C composite material typically contains a carbon domain and a Si-containing domain. Incidentally, the first Si-containing particle 14 and the second Si-containing particle 18 might not be the Si—C composite material, or might be a Si particle, a Si oxide particle, or the like.

The carbon domain is, for example, a carbonide of a carbon precursor (for example, a petroleum pitch, a coal pitch, a phenolic resin, or the like); a graphite; or the like. The carbon domain suitably configures a carbon matrix. Thus, the Si—C composite material is suitably a material in which plural Si-containing domains are dispersed into a carbon matrix. In this case, the carbon matrix can relieve the volume change caused by the expansion/contraction of the Si-containing domain, and thus it is advantageous.

The Si-containing domain contains the Si, and is configured with, for example, the Si, a Si oxide (SiOₓ), a Si nitride (SiNₓ), a Si carbide (SiCₓ), or the like. The Si-containing domain is preferably configured with at least any of the Si and the Si oxide (SiOₓ). The Si-containing domain might be a fine particle. An oxygen content amount of the Si-containing domain is preferably equal to or less than 10 mass %.

A mean particle diameter of the Si-containing domain is, for example, equal to or less than 50 nm, or might be 5 nm to 50 nm. Incidentally, said “mean particle diameter of the Si-containing domain” can be obtained as described below. At first, the negative electrode active material layer 64 is subjected to a FIB (a focused ion beam) processing, so as to manufacture a specimen for a scan transmission electron microscope (STEM) observation. Then, after this specimen is subjected to an element analysis by EDX elemental mapping, a BF image (a bright field image) and a HAADF image (a high angle annular dark field image) are obtained. From a contrast and a shape obtained with the BF image and the HAADF image, it is possible to obtain a diameter of the Si-containing domain. Diameters of arbitrarily selected 10 or more Si-containing domains are obtained, and a mean value of them herein is treated as said “mean particle diameter of the Si-containing domain”.

In the present description, a Si content rate (S1) in the first Si-containing particle 14 and a Si content rate (S2) in the second Si-containing particle 18 are not particularly restricted. However, if these Si content rates are too low, there is a fear that it is not implemented to make the secondary battery have the higher capacity. On the other hand, if these Si content rates are too high, when the electrical charge and the electrical discharge are repeated on the secondary battery, there is a fear that the volume change caused by the expansion/contraction of the first Si-containing particle 14 and the second Si-containing particle 18 becomes too large.

Thus, for example, in a situation where the first Si-containing particle 14 consisting of the Si—C composite material is used, the Si content rate (S1) in this particle is preferably 20 mass % to 55 mass %, or further preferably 25 mass % to 45 mass %. The Si content rate (S2) in the second Si-containing particle 18 is preferably 45 mass % to 80 mass %, or further preferably 55 mass % to 75 mass %.

Incidentally, the first Si-containing particle 14 and the second Si-containing particle 18 can be manufactured by a well known method. Incidentally, various manufacturing methods of the particle of the Si—C composite material are well known (see, for example, Japanese Patent Application Publication No. 2015-38862, International Patent Publication No. 2014/046144, prior art documents recited in these publications, or the like).

In the present description, the first Si-containing particle 14 and the second Si-containing particle 18 are defined by an expansion rate P and a mean particle diameter M. Incidentally, these values are independent from each other, and are not a value depending on the above described Si content rate.

### Expansion Rate P

In the present description, the expansion rate P is an indicator that indicates a degree of the expansion of the Si—C containing particles before and after the electrical charge, and can be derived, for example, by a following procedure.

An electrode plate before the electrical charge is subjected to a cross section processing, a SEM image of a processing surface is obtained, and then a cell is manufactured. After a CCCV electrical charge (for example, 0.01 C electrical charge_4.2 V_0.005 C cut) is performed under 25° C. environment, the cell is disassembled so as to obtain the SEM of a cross section processing part. Area sizes of an arbitrary Si—C containing particle before and after the electrical charge are calculated with ImageJ, and then the expansion rate P can be derived with the below described Formula (1). In Formula (1), a cross-sectional area size of the Si—C containing particle obtained from the SEM image is subjected to one-half power so as to convert it into a length indicator, and the value is further subjected to third power so as to convert it into a volume indicator.

Expansion rate P=(Cross-sectional area size of Si-containing particle after electrical charge)^{3/2}/(Cross-sectional area size of Si-containing particle after electrical charge)^{3/2} Formula (1)·

### Mean Particle Diameter M

As described above, the mean particle diameter M represents a median diameter (D50), and represents a particle diameter corresponding to cumulative frequency 50 volume % from a side of a fine particle, whose particle diameter is smaller, with respect to a particle size distribution on a volume basis according to a laser diffraction and scattering method. The mean particle diameter (D50) can be obtained with a commercially available particle size distribution measuring device configured in a laser diffraction and scattering style, or the like.

Incidentally, the negative electrode active material layer 64 might contain a component other than the negative electrode active material, and it is possible as an example of it to use a binder, an electrically conducting material, or the like. As the binder, for example, it is possible to use a styrene butadiene rubber (SBR), carboxymethyl cellulose (CMC), polyacrylic acid (PAA), polyvinylidene fluoride (PVDF), or the like. The CMC functions as a thickening agent, too. As an example of the electrically conducting material, it is possible to use a carbon black, such as acetylene black, a carbon fiber, a carbon nanotube (CNT), or the like. Among them, the CNT is preferable. In a situation where the CNT is used as the electrically conducting material, the negative electrode active material layer 64 might contain a dispersing agent for the CNT.

### (2) Suppress of Negative Electrode Plate Expansion

When the electrical charge and the electrical discharge are performed on the secondary battery, the negative electrode active material layer near the negative electrode current collector significantly suffers an effect of the expansion of the negative electrode active material positioned closer to the surface side, and there is a tendency that the expansion is inhibited. Conversely, the negative electrode active material positioned near the surface of the negative electrode active material layer does not have a factor by which the expansion is inhibited. In other words, regarding the negative electrode active material layer 64 in which the negative electrode active material layer is configured with a 2-layers structure, a portion whose swell is larger when the electrical charge and the electrical discharge are repeated on the secondary battery is the upper layer (in other words, the first layer 64a). Below, from a perspective of the expansion rate P, the mean particle diameter M, and the content amount of the Si—C containing particle (here, the Si—C composite material is used) regarding the first layer 64a and the second layer 64b, and of the thickness T regarding the first layer 64a and the second layer 64b, suppressing the negative electrode plate expansion is explained.

### (A) Expansion Rate P

In the negative electrode active material layer according to one embodiment, on the upper layer, the first Si-containing particle 14 having a low expansion rate (which represents the expansion rate being equal to or less than 180%), in other words, the Si-containing particle whose expansion/contraction is small is used. By doing this, the particles become more easily moving on the upper layer part, the particles follow the expansion/contraction due to the electrical charge and discharge so as to relieve the stress, and thus it is possible to suppress the swell of the negative electrode.

On the other hand, on the lower layer part, the second Si-containing particle 18 having a high expansion rate (which represents the expansion rate being more than 180%), in other words, the Si-containing particle whose expansion/contraction is large is used. By doing this, the particles become more hardly moving on the lower layer part, and thus it is possible to suppress a disconnection of a conducting path at an electrical charge and discharge time. Thus, it is possible to suppress the swell of the negative electrode caused by the disconnection of the electrically conductive path (the swell or the like, caused by battery response becoming not-consistent so as to have a response or a stress being locally concentrated). As the result, on the whole of the negative electrode active material layer 64, it is possible to significantly suppress the swell of the negative electrode 60 when the electrical charge and the electrical discharge are repeated on the secondary battery.

A ratio (P1/P2) of the expansion rate P2 of the second Si-containing particle 18 with respect to the expansion rate P1 of the first Si-containing particle 14 is, from a perspective of making the secondary battery have the higher capacity, preferably equal to or more than 0.50, further preferably equal to or more than 0.55, or preferably in particular equal to or more than 0.60. On the other hand, from a perspective of suppressing the swell of the negative electrode plate and inhibiting the disconnection of the electrically conductive path at the electrical charge and discharge time, it is preferably equal to or less than 0.80, further preferably equal to or less than 0.75, or preferably in particular equal to or less than 0.70.

### (B) Mean Particle Diameter M

In the negative electrode active material layer according to one embodiment, on the upper layer, the first Si-containing particle 14 having a small particle diameter (which represents a particle diameter being equal to or less than 4 μm), in other words, the Si-containing particle whose particle diameter after the expansion is comparatively small is used. By doing this, on the upper layer part, the particles become more easily moving, the particles follow the expansion/contraction due to the electrical charge and discharge so as to relieve the stress, and thus it is possible to suppress the swell of the negative electrode.

On the other hand, on the lower layer part, the second Si-containing particle 18 having a large particle diameter (which represents a particle diameter being more than 4 μm), in other words, the Si-containing particle whose particle diameter after the expansion is comparatively large, whose contraction is large, and whose filling ability is low is used. By doing this, the particles become hardly moving on the lower layer part, and thus it is possible to suppress the disconnection of the conducting path at the electrical charge and discharge time. Thus, it is possible to suppress the swell of the negative electrode caused by the disconnection of the electrically conductive path (the swell or the like, caused by battery response becoming not-consistent so as to have a response or a stress being locally concentrated). As the result, on the whole of the negative electrode active material layer 64, it is possible to significantly suppress the swell of the negative electrode 60 when the electrical charge and the electrical discharge are repeated on the secondary battery.

A ratio (P1/P2) of the mean particle diameter M2 of the second Si-containing particle 18 with respect to the mean particle diameter M1 of the first Si-containing particle 14 is, from a perspective of making the secondary battery have the higher capacity, preferably equal to or more than 0.40, further preferably equal to or more than 0.44, or preferably in particular equal to or more than 0.48. On the other hand, from a perspective of suppressing the swell of the negative electrode plate and inhibiting the disconnection of the path at the electrical charge and discharge time, preferably equal to or less than 0.60, further preferably equal to or less than 0.56, or preferably in particular equal to or less than 0.52.

A ratio of the mean particle diameter (D50) of the first graphite particle 12 with respect to the mean particle diameter (D50) of the first Si-containing particle 14 (D50 of the first graphite particle 12/D50 of the first Si-containing particle 14) is not particularly restricted. From a perspective of implementing the higher filling ability, the ratio (D50 of the first graphite particle 12/D50 of the first Si-containing particle 14) is preferably 1.0 to 8.0, further preferably 1.0 to 5.0, furthermore preferably 1.2 to 3.0, or preferably in particular 1.4 to 2.5.

A ratio of the mean particle diameter (D50) of the second graphite particle 16 with respect to the mean particle diameter (D50) of the second Si-containing particle 18 (D50 of the second graphite particle 16/D50 of the second Si-containing particle 18) is not particularly restricted. From a perspective of implementing the higher filling ability, the ratio (D50 of the second graphite particle 16/D50 of the second Si-containing particle 18) is preferably 1.0 to 8.0, further preferably 1.0 to 5.0, furthermore preferably 1.2 to 3.0, or preferably in particular 1.4 to 2.5.

### (C) Content Amount

In the negative electrode active material layer according to one embodiment, on the upper layer, a content amount of the second Si-containing particle 18 whose expansion rate is low and whose particle diameter is small is comparatively low. By doing this, the particle on the upper layer part becomes more easily moving, the particle follows the expansion/contraction due to the electrical charge and discharge so as to relieve the stress, and thus it is possible to suppress the swell of the negative electrode.

On the other hand, on the lower layer part, a content amount of the first Si-containing particle 14 whose expansion rate is high and whose particle diameter is large is comparatively high. By doing this, the particles become hardly moving on the lower layer part, and thus it is possible to suppress the disconnection of the conducting path at the electrical charge and discharge time. Thus, it is possible to suppress the swell of the negative electrode caused by the disconnection of the electrically conductive path (the swell or the like, caused by battery response becoming not-consistent so as to have a response or a stress being locally concentrated). As the result, on the whole of the negative electrode active material layer 64, it is possible to significantly suppress the swell of the negative electrode 60 when the electrical charge and the electrical discharge are repeated on the secondary battery.

A content amount of the negative electrode active material in the first layer 64a (in other words, with respect to a total mass of the first layer 64a) is preferably equal to or more than 90 mass %, or further preferably equal to or more than 95 mass %. A content amount of the binder in the negative electrode active material layer is preferably equal to or more than 0.1 mass % and not more than 8 mass %, or further preferably equal to or more than 0.5 mass % and not more than 5 mass %. A content amount of the electrically conducting material in the negative electrode active material layer 64 is preferably equal to or more than 0.01 mass % and not more than 3 mass %, or further preferably equal to or more than 0.05 mass % and not more than 1 mass %.

A content amount of the negative electrode active material in the second layer 64b (in other words, with respect to a total mass of the second layer 64b) is preferably equal to or more than 90 mass %, or further preferably equal to or more than 95 mass %. A content amount of the binder in the negative electrode active material layer is preferably equal to or more than 0.1 mass % and not more than 8 mass %, or further preferably equal to or more than 0.5 mass % and not more than 5 mass %. A content amount of the electrically conducting material in the negative electrode active material layer 64 is preferably equal to or more than 0.01 mass % and not more than 3 mass %, or further preferably equal to or more than 0.05 mass % and not more than 1 mass %.

On the first layer 64a, a mass rate N1 of the first Si-containing particle 14 with respect to a total mass of the first graphite particle 12 and the first Si-containing particle 14 is, from a perspective of making the secondary battery have the higher capacity, preferably equal to or more than 10 mass %, or further preferably equal to or more than 15 mass %. On the other hand, from a perspective of suppressing the swell of the negative electrode plate and inhibiting the disconnection of the path at the electrical charge and discharge time, it is preferably equal to or less than 60 mass %, further preferably equal to or less than 40 mass %, or preferably in particular equal to or less than 20%.

On the second layer 64b, a mass rate N2 of the second Si-containing particle 18 with respect to a total mass of the second graphite particle 16 and the second Si-containing particle 18 is, from a perspective of making the secondary battery have the higher capacity, preferably equal to or more than 10 mass %, or further preferably equal to or more than 15 mass %. On the other hand, from a perspective of inhibiting the disconnection of the path at the electrical charge and discharge time, it is preferably equal to or less than 60 mass %, further preferably equal to or less than 40 mass %, or preferably in particular equal to or less than 20%.

The negative electrode active material contained in the first layer 64a might be only the first graphite particle 12 and the first Si-containing particle 14. However, the first layer 64a might contain an additional negative electrode active material, other than the first graphite particle 12 and the first Si-containing particle 14, within a range where the effect of the present disclosure is not inhibited (for example, equal to or less than 10 mass % of a total amount of the negative electrode active material contained in the first layer 64a).

The negative electrode active material contained in the second layer 64b might be only the second graphite particle 16 and the second Si-containing particle 18. However, the second layer 64b might contain additional negative electrode active material, other than the second graphite particle 16 and the second Si-containing particle 18, within a range where the effect of the present disclosure is not inhibited (for example, equal to or less than 10 mass % of a total amount of the negative electrode active material contained in the second layer 64b).

### (D) Thickness T of First Layer and Second Layer

The negative electrode according to one embodiment is formed to have a thickness of the upper layer, among two layers included by the negative electrode active material layer, being comparatively thinner. By doing this, the swell is suppressed on the upper layer part, and as the result, it is possible to suppress the swell of the whole negative electrode.

On the other hand, the lower layer part is formed to have a thickness being comparatively thick. By doing this, the particles on the lower layer part become easily moving, the particles follow the expansion/contraction due to the electrical charge and discharge so as to relieve the stress, and thus it is possible to suppress the swell of the negative electrode. Thus, it is possible to suppress the swell of the negative electrode caused by the disconnection of the electrically conductive path (the swell or the like, caused by battery response becoming not-consistent so as to have a response or a stress being locally concentrated). As the result, on the whole of the negative electrode active material layer 64, it is possible to significantly suppress the swell of the negative electrode 60 when the electrical charge and the electrical discharge are repeated on the secondary battery.

A ratio (T1:T2) of a thickness T2 of the lower layer with respect to a thickness T1 of the upper layer is, from a perspective of suppressing the swell of the negative electrode plate, preferably 10:90 to 90:10, further preferably 20:80 to 80:20, or preferably in particular 30:70 to 70:30.

### (3) Manufacture of Negative Electrode

The negative electrode 60 can be suitably manufactured, for example, by a manufacturing method including a step for mixing the second graphite particle 16 and the second Si-containing particle 18 into a dispersion medium so as to prepare a paste for second layer formation (below, which might be referred to as “negative electrode composite material paste for lower layer”, too); a step for mixing the first graphite particle 12 and the first Si-containing particle 14 into the dispersion medium so as to prepare a paste for first layer formation (below, which might be referred to as “negative electrode composite material paste for upper layer”, too); a step for applying the paste for second layer formation to coat the negative electrode current collector 62 and drying it so as to form the second layer 64b (the lower layer) (below, which might be referred to as “lower layer forming step”, too); a step for applying this paste for first layer formation to coat the second layer 64b and drying it so as to form the first layer 64a (the upper layer) (below, which might be referred to as “upper layer forming step”, too); and a step for pressing the formed first layer 64a and second layer 64b (below, which might be referred to as “pressing step”, too).

Incidentally, in the present description, the term “paste” represents a mixture in which a part or all of solid contents are dispersed into a dispersion medium, and semantically covers so-called “slurry”, “ink”, or the like.

The lower layer formation paste preparing step can be performed, according to a well known method, by mixing the second graphite particle 16, the second Si-containing particle 18, and an arbitrary component (for example, the binder, the electrically conducting material, or the like) with the dispersion medium (for example, water), as using a well known mixing device, stirring device, or the like.

The upper layer formation paste preparing step can be performed, according to a well known method, by mixing the first graphite particle 12, the first Si-containing particle 14, and an arbitrary component (for example, the binder, the electrically conducting material, or the like) with the dispersion medium (for example, water), as using a well known mixing device, stirring device, or the like. Incidentally, the upper layer formation paste preparing step might be performed in parallel to the lower layer formation paste preparing step. The upper layer formation paste preparing step might be performed in parallel to, or after the lower layer forming step.

The lower layer forming step can be performed according to a well known method. In particular, for example, it can be performed by applying the paste for lower layer formation to coat the negative electrode current collector 62 with a well known coating device, and then by drying it. By drying it, the lower layer (the second layer 64b) is formed.

The upper layer forming step can be performed according to a well known method. In particular, for example, it can be performed by applying the paste for upper layer formation to coat the formed lower layer with a well known coating device, and then by drying it. By drying it, the upper layer (the first layer 64a) is formed, so that the negative electrode active material layer 64 is formed.

Although a density of the negative electrode active material layer 64 is not particularly restricted, it is, for example, equal to or more than 0.7 g/cm³, preferably equal to or more than 1.0 g/cm³, or further preferably equal to or more than 1.2 g/cm³. On the other hand, the density of the negative electrode active material layer 64 might be, for example, equal to or less than 2.3 g/cm³, or might be equal to or less than 2.0 g/cm³.

The pressing step can be performed on the basis of a well known method. In particular, by applying a pressure with a roller press, or the like, on the formed upper layer and lower layer (in other words, the negative electrode active material layer 64), the pressing step can be performed. By performing the pressing step, the negative electrode active material layer 64 is compressed to have a predetermined density, and by doing this, the negative electrode active material particle is densely packed.

### 2. Secondary Battery

By the negative electrode 60 in accordance with the present embodiment, it is possible to suppress the swell of the negative electrode 60 when the electrical charge and the electrical discharge are repeated on the secondary battery. The negative electrode 60 in accordance with the present embodiment uses the negative electrode active material containing the Si, and thus it is possible to make the secondary battery have the higher capacity.

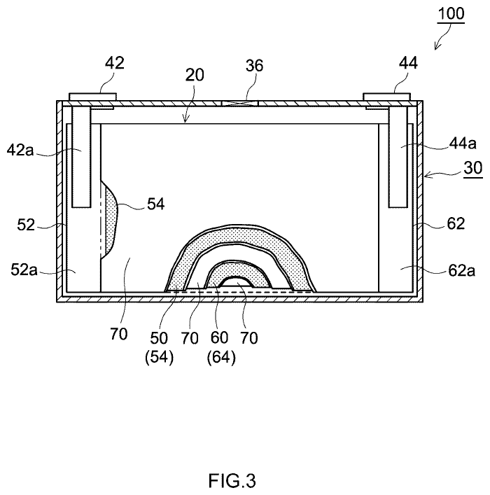

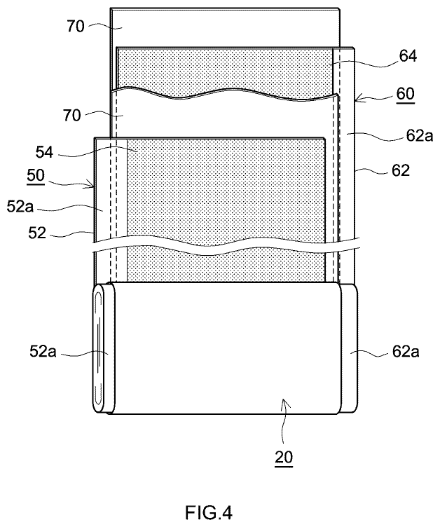

Then, from a different aspect, the herein disclosed secondary battery includes the positive electrode, the negative electrode, and an electrolyte. This negative electrode is the negative electrode 60 in accordance with the above described embodiment. Below, the lithium ion secondary battery is treated as an example, and then one embodiment of the herein disclosed secondary battery would be explained while referring to FIG. 3 and FIG. 4. A below described configuration example is a lithium ion secondary battery that is formed in a flat square shape and that includes a wound electrode assembly formed in a flat shape and includes a battery case formed in a flat shape.

FIG. 3 is a view that schematically shows a configuration of a lithium ion secondary battery constructed with the negative electrode in accordance with one embodiment. The lithium ion secondary battery 100 shown in FIG. 3 is the sealed type lithium ion secondary battery 100 constructed by accommodating the flat-shaped wound electrode assembly 20 and the nonaqueous electrolytic solution (not shown in drawings) in the battery case (in other words, the outer container) 30 formed in a flat square shape. The battery case 30 is provided with a positive electrode terminal 42 and a negative electrode terminal 44 which are for outside connection, and provided with a thin-walled safe valve 36 which is set to release an internal pressure of the battery case 30 when the internal pressure is increased to be equal to or more than a predetermined level. The battery case 30 is provided with an injection port (not shown in drawings) for injecting the nonaqueous electrolytic solution. The positive electrode terminal 42 is electrically connected to a positive electrode current collection plate 42a. The negative electrode terminal 44 is electrically connected to the negative electrode current collection plate 44a. As a material of the battery case 30, for example, it is possible to use a metal material, such as aluminum, being lightweight and having a good thermal conductivity.

FIG. 4 is a schematic exploded view that shows a configuration of the wound electrode assembly of the lithium ion secondary battery shown by FIG. 3. The wound electrode assembly 20 has a form, as shown by FIG. 3 and FIG. 4, in which a positive electrode sheet 50 and a negative electrode sheet 60 are stacked one on another via two long separator sheets 70 and then wound in a longitudinal direction. The positive electrode sheet 50 has a configuration in which a positive electrode active material layer 54 is formed on one surface or both surfaces (here, both surfaces) of a long positive electrode current collector 52 along the longitudinal direction. The negative electrode sheet 60 has a configuration in which the negative electrode active material layer 64 is formed on one surface or both surfaces (here, both surfaces) of the long negative electrode current collector 62 along the longitudinal direction. A positive electrode active material layer non-formation part 52a (in other words, a portion where the positive electrode active material layer 54 is not formed and the positive electrode current collector 52 is exposed) and the negative electrode active material layer non-formation part 62a (in other words, a portion where the negative electrode active material layer 64 is not formed and the negative electrode current collector 62 is exposed) are formed to protrude outwardly from both ends of the wound electrode assembly 20 in the winding axis direction (in other words, a sheet width direction orthogonal to the longitudinal direction). To the positive electrode active material layer non-formation part 52a and the negative electrode active material layer non-formation part 62a, the positive electrode current collection plate 42a and the negative electrode current collection plate 44a are respectively joined.

As the positive electrode current collector 52 configuring the positive electrode sheet 50, it is possible to use a well known positive electrode current collector that is used for the lithium ion secondary battery, and it is possible as an example of it to use a sheet or a foil which is made from a metal having the good electrically conductive property (for example, aluminum, nickel, titanium, stainless steel, or the like). As the positive electrode current collector 52, it is preferable to use the aluminum foil.

A size of the positive electrode current collector 52 is not particularly restricted, and can be decided suitably according to a battery design. In a situation where the aluminum foil is used as the positive electrode current collector 52, a thickness of it is not particularly restricted, but is, for example, equal to or more than 5 μm and not more than 35 μm, or preferably equal to or more than 7 μm and not more than 20 μm.

The positive electrode active material layer 54 contains a positive electrode active material. As the positive electrode active material, it is possible to use a positive electrode active material which is used for the lithium ion secondary battery and whose composition is well known. In particular, for example, it is possible as the positive electrode active material to use a lithium composite oxide, a lithium transition metal phosphate compound, or the like. A crystal structure of the positive electrode active material is not particularly restricted, but might be a layered structure, a spinel structure, an olivine structure, or the like.

Regarding the lithium composite oxide, it is preferable as a transition metal element to use a lithium transition metal complex oxide containing at least 1 kind among Ni, Co, and Mn, and it is possible as a specific example of it to use a lithium nickel base composite oxide, a lithium cobalt base composite oxide, a lithium manganese base composite oxide, a lithium nickel manganese base composite oxide, a lithium nickel cobalt manganese base composite oxide, a lithium nickel cobalt aluminum base composite oxide, a lithium iron nickel manganese base composite oxide, or the like.

Incidentally, the term “lithium nickel cobalt manganese base composite oxide” in the present description is a term semantically covering not only the oxide whose constituent element is Li, Ni, Co, Mn, or O, but also an oxide containing 1 kind, 2 kinds, or more kinds of additive elements other than them. As an example of the additive element described above, it is possible to use a transition metal element, such as Mg, Ca, Al, Ti, V, Cr, Y, Zr, Nb, Mo, Hf, Ta, W, Na, Fe, Zn, and Sn, a typical metal element, or the like. The additive element might be a semimetal element, such as B, C, Si, and P, or a non-metal element, such as S, F, Cl, Br, and I. This matter is similar even on the above described lithium nickel base composite oxide, lithium cobalt base composite oxide, lithium manganese base composite oxide, lithium nickel manganese base composite oxide, lithium nickel cobalt aluminum base composite oxide, lithium iron nickel manganese base composite oxide, or the like.

As the lithium transition metal phosphate compound, it is possible to use, for example, lithium iron phosphate (LiFePO₄), lithium manganese phosphate (LiMnPO₄), lithium manganese iron phosphate, or the like.

Regarding these positive electrode active materials, 1 kind might be used alone, or 2 or more kinds might be combined so as to be used. As the positive electrode active material, the lithium nickel cobalt manganese base composite oxide is especially preferable because it has superior characteristics, such as initial resistance characteristic.

The mean particle diameter (D50) of the positive electrode active material is not particularly restricted, but is, for example, equal to or more than 0.05 μm and not more than 25 μm, preferably equal to or more than 1 μm and not more than 20 μm, or further preferably equal to or more than 3 μm and not more than 15 μm.

The positive electrode active material layer 54 might contain a component other than the positive electrode active material, such as trilithium phosphate, electrically conducting material, and binder. As the electrically conducting material, it is possible to suitably use, for example, a carbon black, such as acetylene black (AB); a carbon fiber, such as vapor grown carbon fiber (VGCF) and carbon nanotube (CNT); or another carbon material (for example, a graphite, or the like). As the binder, it is possible to use, for example, polyvinylidene fluoride (PVdF), or the like.

A content amount of the positive electrode active material in the positive electrode active material layer 54 (in other words, a content amount of the positive electrode active material with respect to a total mass of the positive electrode active material layer 54) is not particularly restricted, but preferably equal to or more than 70 mass %, further preferably equal to or more than 80 mass %, or furthermore preferably equal to or more than 85 mass % and not more than 99 mass %. The content amount of the trilithium phosphate in the positive electrode active material layer 54 is not particularly restricted, but is preferably equal to or more than 0.1 mass % and not more than 15 mass %, or further preferably equal to or more than 0.2 mass % and not more than 10 mass %. The content amount of the electrically conducting material in the positive electrode active material layer 54 is not particularly restricted, but preferably equal to or more than 0.1 mass % and not more than 20 mass %, or further preferably equal to or more than 0.3 mass % and not more than 15 mass %. A content amount of the binder in the positive electrode active material layer 54 is not particularly restricted, but preferably equal to or more than 0.4 mass % and not more than 15 mass %, or further preferably equal to or more than 0.5 mass % and not more than 10 mass %.

A thickness per one surface of the positive electrode active material layer 54 is not particularly restricted, but is normally equal to or more than 10 μm, or preferably equal to or more than 20 μm. On the other hand, this thickness is normally equal to or less than 400 μm, or preferably equal to or less than 300 μm.

As the negative electrode sheet 60, the above described negative electrode 60 is used.

As the separator 70, it is possible to use, for example, a porous sheet (film) configured with a resin, such as polyethylene (PE), polypropylene (PP), polyester, cellulose, and polyamide. The porous sheet described above might have a single layer structure, or might have two or more layers laminate structure (for example, a three layers structure in which PP layers are laminated on both surfaces of a PE layer). On a surface of the separator 70, a heat resistance layer (HRL) might be provided.

A thickness of the separator 70 is not particularly restricted, but is, for example, equal to or more than 5 μm and not more than 50 μm, or preferably equal to or more than 10 μm and not more than 30 μm. An air permeability of the separator 70 obtained by Gurley test is not particularly restricted, but is preferably equal to or less than 350 second/100 cc.

The nonaqueous electrolytic solution contains, typically, a nonaqueous solvent and a supporting salt (an electrolyte salt). As the nonaqueous solvent, it is possible without particular restriction to use an organic solvent, such as carbonates, ethers, esters, nitriles, sulfones, and lactones, which can be used for the electrolytic solution of a general lithium ion secondary battery. Among them, the carbonates are preferable, and it is possible as a specific example of them to use ethylene carbonate (EC), propylene carbonate (PC), diethyl carbonate (DEC), dimethyl carbonate (DMC), ethyl methyl carbonate (EMC), monofluoroethylene carbonate (FEC), difluoroethylene carbonate (DFEC), monofluoromethyl difluoromethyl carbonate (F-DMC), trifluoro dimethyl carbonate (TFDMC), or the like. Regarding the nonaqueous solvents as described above, it is possible to use 1 kind alone or to combine 2 or more kinds so as to use the resultant. As one example, the nonaqueous solvent consists of only the carbonates. As another example, the nonaqueous solvent contains the carbonates and the esters, such as methyl acetate.

As the supporting salt, it is possible to suitably use, for example, a lithium salt, such as LiPF₆, LiBF₄, and lithium bis(fluorosulfonyl)imide (LiFSI) (preferably, the LiPF₆). A concentration of the supporting salt is preferably equal to or more than 0.7 mol/L and not more than 1.3 mol/L.

Incidentally, the above described nonaqueous electrolytic solution might contain a component other than the above described components, insofar as the effect of the present disclosure is not significantly spoiled, and thus might contains, for example, various additive agents which might be a coating layer forming agent, such as vinylene carbonate (VC) and oxalate complex; a gas generating agent, such as biphenyl (BP) and cyclohexylbenzene (CHB); a thickening agent; or the like.

The lithium ion secondary battery 100, in which the swell of the negative electrode when the electrical charge and the electrical discharge are repeated is suppressed, is a low reaction force. In addition, the lithium ion secondary battery 100 has the higher capacity. The lithium ion secondary battery 100 can be used for various purposes. As a suitable usage, it is possible to apply it for a driving power supply mounted on a vehicle, such as battery electric vehicle (BEV), hybrid electric vehicle (HEV), and plug-in hybrid electric vehicle (PHEV). In addition, the lithium ion secondary battery 100 can be used as a storage battery, such as small electric power storage device. The lithium ion secondary battery 100 can be used, typically, in a form of a battery pack in which plural ones are connected in series and/or in parallel.

Above, as one example, the square-shaped lithium ion secondary battery 100 including the flat-shaped wound electrode assembly 20 has been explained. However, the lithium ion secondary battery can be configured to be a lithium ion secondary battery including a laminate type electrode assembly (in other words, an electrode assembly in which plural positive electrodes and plural negative electrodes are alternately laminated), too. In addition, the lithium ion secondary battery can be configured to be a cylindrical-shaped lithium ion secondary battery, a laminate case type lithium ion secondary battery, or the like.

In addition, according to a well known method, the lithium ion secondary battery 100 can be configured to be an all-solid state lithium ion secondary battery in which a solid electrolyte is used instead of the nonaqueous electrolyte, too.

In addition, the negative electrode 60 in accordance with the present embodiment is suitable for the negative electrode of the lithium ion secondary battery, but can be constructed for the negative electrode of the other secondary battery so as to be used, and the other secondary battery can be configured according to a well known method.

### <<Evaluation>>

### 1. TEST EXAMPLE

Below, a test example related to the herein disclosed technique is explained, but it is not intended that the herein disclosed technique is restricted to the test example described above.

### (1) Practical Example 1

### Manufacture of Negative Electrode

A graphite particle C and the second Si-containing particle (expansion rate P2: 200%, particle diameter M2: 7 μm) as the negative electrode active material, a SWCNT as the electrically conducting material, and a CMC, a PAA, and a SBR as the binder, were weighed so as to make a mass ratio satisfy C:second Si-containing particle:SWCNT:CMC:PAA:SBR=85:15:0.1:1:1:1.5. Among them, raw materials other than the SWCNT and the SBR were dry-mixed, then the SWCNT and the dispersion medium were mixed and were subjected to hard kneading, and then the SBR and the dispersion medium were put into and then were diluted and mixed, so that the negative electrode composite material paste for lower layer was manufactured. Incidentally, the hard kneading is required to make a pressure load onto the paste be optimized in order to cover an active material periphery with the binder (CMC/PAA). In order to make this pressure load be optimized, an ideal solid content ratio B₀ of the paste was derived by the below described Formula (1).

$${B}_{0} = 100 - {A}_{0} = \{ 100 / ( 100 + {A}_{1} ) \} \times 100 \qquad Formula ( 1 )$$

$${B}_{0} : Ideal solid content ratio [ \% ]$$

$${A}_{0} : Moisture rate at which a torque required for mixing becomes maximum [ \% ]$$

$${A}_{1} : Moisture amount when a mixture is set to be 100 g [ mL ]$$

Next, by the same manufacturing method, other than using the first Si-containing particle (expansion rate P1: 130%, particle diameter M1: 3.5 μm) instead of the second Si-containing particle, the negative electrode composite material paste for upper layer was manufactured.

Then, the negative electrode composite material paste for lower layer was applied to coat the negative electrode substrate (the copper foil, 10 μm), and then it was dried. By applying the negative electrode composite material paste for upper layer after the dry to coat the negative electrode composite material paste for lower layer and then drying it so as to make the ratio T1:T2 of the upper layer thickness T1 and the lower layer thickness T2 become 50:50, the negative electrode active material layer (expansion rate ratio P1/P2=0.65, particle diameter ratio M1/M2=0.5) configured with the 2-layers structure was provided on the negative electrode substrate. After that, by performing a pressing process to roll and to process so as to have a predetermined size, the negative electrode plate was obtained.

### Manufacture of Positive Electrode

The lithium-nickel-cobalt-manganese base composite oxide (NCM) as the positive electrode active material, the polyvinylidene fluoride (PVdF) as the binder, and the acetylene black (AB) as the electrically conducting material were weighed to make the mass ratio satisfy NCM:PVdF:AB=100:1:1, and were mixed in the N-methyl-2-pyrrolidone (NMP), so that the positive electrode composite material paste was prepared. This positive electrode composite material paste was applied to coat a positive electrode substrate (aluminum foil, thickness was 15 μm) formed in a long strip-like shape, and then it was dried. After that, by performing a pressing process to roll and to process so as to have a predetermined size, the positive electrode plate was obtained.

To each of the negative electrode and the positive electrode, a lead was attached, and then each electrode was laminated via the separator, so that the electrode assembly was manufactured. The manufactured electrode assembly was inserted into an outer case configured with an aluminum laminate sheet, the nonaqueous electrolyte was injected, and then an opening part of the outer case was sealed, so that a test cell (a laminate cell) was manufactured.

As the nonaqueous electrolytic solution, a solution was used in which the LiPF₆ was dissolved at a concentration being 1 M into a mixed solvent containing the ethylene carbonate (EC), the fluoro ethylene carbonate (FEC), the ethyl methyl carbonate (EMC), and the dimethyl carbonate (DMC) at a volume ratio being EC:FEC:EMC:DMC=15:5:40:40.

### (2) Practical Example 2

The test cell was manufactured similarly to Practical example 1, other than making the expansion rate ratio P1/P2 be 0.8.

### (3) Practical Example 3

The test cell was manufactured similarly to Practical example 1, other than making the thickness ratio T1:T2 of the upper layer and the lower layer be 70:30.

### (4) Practical Example 4

The test cell was manufactured similarly to Practical example 1, other than making the thickness ratio T1:T2 of the upper layer and the lower layer be 30:70.

### (5) Comparative Example 1

The test cell was manufactured similarly to Practical example 1, other than making the negative electrode active material layer be configured with a single layer containing the first Si-containing particle and the second Si-containing particle. Incidentally, a composition of the composite material paste forming the negative electrode active material layer is adjusted to make the mass ratio satisfy C:second Si-containing particle:first Si-containing particle:SWCNT:CMC:PAA:SBR=85:7.5:7.5:0.1:1:1:1.5.

### (6) Comparative Example 2

The test cell was manufactured similarly to Practical example 1, other than making the expansion rate ratio P1/P2 be 1.5.

### (7) Comparative Example 3

The test cell was manufactured similarly to Practical example 1, other than making the particle diameter ratio M1/M2 be 1.0.

### 2. EVALUATION TEST

### (1) Measurement of Expansion Rates P of First Si-Containing Particle and Second Si-Containing Particle

The negative electrode plate before the electrical charge was subjected to the cross section processing, and thus the SEM image of the processing surface was obtained. After the SEM image was obtained, the test cell was manufactured, and then the CCCV electrical charge (0.01 C_4.2 V_0.005 C cut) was performed under the 25° C. environment. After the electrical charge, the cell was disassembled, the SEM image of the cross section processing part was obtained, the area sizes of the arbitrary Si—C containing particle before and after the electrical charge were calculated with the ImageJ, and then the expansion rate P was calculated with the below described Formula (2).

$$Formula ( 2 )$$

$$Expansion rate P = {( Cross - sectional area size of Si - containing particle after electrical charge )}^{3 / 2} / {( Cross - sectional area size of Si - containing particle after electrical charge )}^{3 / 2}$$

### (2) Negative Electrode Plate Expansion Rate Evaluation

The test cell was manufactured, and then the electrical charge and discharge was repeatedly performed to satisfy 250 cycles while the CCCV electrical charge (0.4 C_4.2 V_0.1 C cut)−CC discharge (0.4 C_2.5 V cut) under the 25° C. environment was treated as 1 cycle. Then, with the below described Formula (3), the negative electrode plate expansion rate was derived.

$$Formula ( 3 )$$

$$Negative electrode plate expansion rate = \{ ( Thickness of test cell after 250 cycles ) / ( Thickness of test cell after 250 cycles ) - 1 \} \times 100$$

### 3. EVALUATION RESULT

The test results of each sample are summarized on Table 1 and Table 2.

TABLE 1

| | | Expansion | Expansion | Particle | Particle | | |
|---|---|---|---|---|---|---|---|
| | Negative | rate P1 of | rate P2 of | diameter M1 | diameter M2 | | |
| | electrode | first Si- | second Si- | of first Si- | of second Si- | Thickness | Thickness |
| | active | containing | containing | containing | containing | T1 of | T2 of |
| | material | particle | particle | particle | particle | upper layer | lower layer |
| | layer | [%] | [%] | [μm] | [μm] | [μm] | [μm] |
| Practical example 1 | Two layers | 130 | 200 | 3.5 | 7.0 | 30 | 30 |
| Practical example 2 | Two layers | 160 | 200 | 3.5 | 7.0 | 30 | 30 |
| Practical example 3 | Two layers | 130 | 200 | 3.5 | 7.0 | 42 | 18 |
| Practical example 4 | Two layers | 130 | 200 | 3.5 | 7.0 | 18 | 42 |
| Comparative example 1 | Single layer | 130 | 200 | 3.5 | 7.0 | — | — |
| Comparative example 2 | Two layers | 200 | 130 | 3.5 | 7.0 | 30 | 30 |
| Comparative example 3 | Two layers | 130 | 200 | 7.0 | 7.0 | 30 | 30 |

TABLE 2

| | Negative | | | Thickness ratio | Negative |
|---|---|---|---|---|---|
| | electrode active | Expansion rate | Particle diameter | T1:T2 of upper layer | electrode plate |
| | material layer | ratio P1/P2 | ratio M1/M2 | and lower layer | expansion rate [%] |
| Practical | Two layers | 0.65 | 0.5 | 50:50 | 29 |
| example 1 | | | | | |
| Practical | Two layers | 0.80 | 0.5 | 50:50 | 36 |
| example 2 | | | | | |
| Practical | Two layers | 0.65 | 0.5 | 70:30 | 39 |
| example 3 | | | | | |
| Practical | Two layers | 0.65 | 0.5 | 30:70 | 25 |
| example 4 | | | | | |
| Comparative | Single layer | 0.65 | 0.5 | — | 45 |
| example 1 | | | | | |
| Comparative | Two layers | 1.50 | 0.5 | 50:50 | 51 |
| example 2 | | | | | |
| Comparative | Two layers | 0.65 | 1.0 | 50:50 | 50 |
| example 3 | | | | | |

From the above described results, Practical examples 1 to 4 included the negative electrode active material layer configured with the 2-layers structure and had an aspect in which the upper layer side became hardly expanded, and thus it was confirmed that the negative electrode plate expansion rate was comparatively lower.

On the other hand, the comparative example 1 included 2 kinds of Si—C containing particles contained in the negative electrode active material layer, but the structure of the negative electrode active material layer was the single layer, and thus the effect of suppressing the negative electrode plate expansion rate was not suitably implemented.

In addition, Comparative examples 2 and 3 included the negative electrode active material layer configured with the 2-layers structure, but had an aspect in which the upper layer was more easily expanded, and thus the effect of reducing the negative electrode plate expansion rate was not suitably implemented.

From the above described results, it was confirmed that, in order to reduce the negative electrode plate expansion rate, it was required to make the negative electrode active material layer be configured with 2-layers, and to have the aspect in which the upper layer side was made to be hardly expanded.

As described above, the present description contains the disclosure recited by each item described below.
Item 1: A negative electrode for a secondary battery, comprising:
   a negative electrode current collector; and
   a negative electrode active material layer that is supported by the negative electrode current collector, wherein
   the negative electrode active material layer comprises a lower layer positioned at a side of the negative electrode current collector and an upper layer positioned at a surface side,
   the upper layer comprises a first graphite particle and a first Si-containing particle, as a negative electrode active material,
   the lower layer comprises a second graphite particle and a second Si-containing particle, as the negative electrode active material,
   an expansion rate P1 of the first Si-containing particle is smaller than an expansion rate P2 of the second Si-containing particle, and
   a mean particle diameter M1 of the first Si-containing particle is smaller than a mean particle diameter M2 of the second Si-containing particle.
Item 2: The negative electrode recited in Item 1, wherein
   a ratio P1/P2 of the P1 and the P2 is 0.5 to 0.8.
Item 3: The negative electrode recited in Item 1 or 2, wherein
   a ratio M1/M2 of the M1 and the M2 is 0.4 to 0.6.
Item 4: The negative electrode recited in any one of Items 1 to 3, wherein
   a ratio T1:T2 of a thickness T1 of the upper layer and a thickness T2 of the lower layer is 10:90 to 90:10.
Item 5: The negative electrode recited in any one of Items 1 to 4, wherein
   a mass rate N1 of the first Si-containing particle with respect to a total mass of the first graphite particle and the first Si-containing particle on the upper layer is 10 to 60 mass %, and
   a mass rate N2 of the second Si-containing particle with respect to a total mass of the second graphite particle and the second Si-containing particle on the lower layer is 10 to 60 mass %.
Item 6: The secondary battery, comprising:
   a positive electrode;
   a negative electrode; and
   an electrolyte, wherein
   the negative electrode is the negative electrode recited in any one of Items 1 to 5.

### REFERENCE SIGNS LIST

12 First graphite particle
14 First Si-containing particle
16 Second graphite particle
18 Second Si-containing particle
20 Wound electrode assembly
30 Battery case
36 Safe valve
42 Positive electrode terminal
42a Positive electrode current collection plate
44 Negative electrode terminal
44a Negative electrode current collection plate
50 Positive electrode sheet (positive electrode)
52 Positive electrode current collector
52a Positive electrode active material layer non-formation part
54 Positive electrode active material layer
60 Negative electrode sheet (negative electrode)
62 Negative electrode current collector
62a Negative electrode active material layer non-formation part
64 Negative electrode active material layer
70 Separator sheet (separator)
100 Lithium ion secondary battery

What is claimed is:

1. A negative electrode for a secondary battery, comprising:
a negative electrode current collector; and
a negative electrode active material layer that is supported by the negative electrode current collector, wherein
the negative electrode active material layer comprises a lower layer positioned at a side of the negative electrode current collector and an upper layer positioned at a surface side,
the upper layer comprises a first graphite particle and a first Si-containing particle, as a negative electrode active material,
the lower layer comprises a second graphite particle and a second Si-containing particle, as the negative electrode active material,
an expansion rate P1 of the first Si-containing particle is smaller than an expansion rate P2 of the second Si-containing particle, and
a mean particle diameter M1 of the first Si-containing particle is smaller than a mean particle diameter M2 of the second Si-containing particle.

2. The negative electrode according to claim 1, wherein
a ratio P1/P2 of the P1 and the P2 is 0.5 to 0.8.

3. The negative electrode according to claim 1, wherein
a ratio M1/M2 of the M1 and the M2 is 0.4 to 0.6.

4. The negative electrode according to claim 1, wherein
a ratio T1:T2 of a thickness T1 of the upper layer and a thickness T2 of the lower layer is 10:90 to 90:10.

5. The negative electrode according to claim 1, wherein
a mass rate N1 of the first Si-containing particle with respect to a total mass of the first graphite particle and the first Si-containing particle on the upper layer is 10 to 60 mass %, and
a mass rate N2 of the second Si-containing particle with respect to a total mass of the second graphite particle and the second Si-containing particle on the lower layer is 10 to 60 mass %.

6. A secondary battery, comprising a positive electrode;
a negative electrode; and
an electrolyte, wherein
the negative electrode is the negative electrode according to claim 1.

7. A secondary battery, comprising:
a positive electrode;
a negative electrode; and
an electrolyte, wherein
the negative electrode is the negative electrode according to claim 2.

8. A secondary battery, comprising:
a positive electrode;
a negative electrode; and
an electrolyte, wherein
the negative electrode is the negative electrode according to claim 3.

9. A secondary battery, comprising:
a positive electrode;
a negative electrode; and
an electrolyte, wherein
the negative electrode is the negative electrode according to claim 4.

10. A secondary battery, comprising:
a positive electrode;
a negative electrode; and
an electrolyte, wherein
the negative electrode is the negative electrode according to claim 5.
